(19) United States
(12) Patent Application Publication
(10) Pub. No.: US 2015/0035215 A1
(43) Pub. Date: Feb. 5, 2015

(54) FIXTURE SYSTEM

(71) Applicant: Jon Baklund, Hutchinson, MN (US)

(72) Inventor: Jon Baklund, Hutchinson, MN (US)

(21) Appl. No.: 13/958,726

(22) Filed: Aug. 5, 2013

(51) Int. Cl. F16B 13/06; B23Q 3/10

(52) U.S. Cl. CPC F16B 13/063; B23Q 3/105
USPC 269/53

(57) ABSTRACT

The present invention relates to tooling used to facilitate machining of component parts or work-pieces. The present tooling fixture is especially well suited to precision machining on large cast and forged component weighing in rough form approximately 1500 lbs. and overall linear dimensions of approximately 4-9 feet.

### BACKGROUND OF THE INVENTION

It is common to make specialized tooling or fixtures to facilitate machining operations, or machining steps on large castings or forgings. Typically the fixture or tooling supports the weight of the work-piece and permits the work-piece to be sequentially repositioned on various machine tools to sequentially brings the work-piece to competition.

Classically, a work pieces with two parallel holes would have the two holes machined on the same machine without being released to ensure parallelism between the holes. With the holes both parallel and square with respect to each other it is normal and conventional to release the component and to pick up the holes in the next companion fixture. It would be common practice to use the holes themselves as reference locations for the next sequential machining operation.

In contrast to this practice inventive fixture pins are inserted into the holes and they remain in place while the workspace is moved from machine to machine.

### SUMMARY OF THE INVENTION

In contrast to the conventional practice the present invention comprises a unique fixture pin that travel with the work-piece and that is not released from the component until final work-piece finishing operations are taking place. The fixture pin maintains great clamping force and remains concentric with the holes. The fixture pin has a double taper core piece. A central screw with right and left hand threads cooperates with end caps to draw a segmented collet sleeves along the tapers to engage the predrilled hole formed in the work-piece.

### BRIEF DESCRIPTION OF THE DRAWINGS

Throughout the figures like reference numerals indicate identical structures wherein;

FIG. 1 is an exploded view of the inventive fixture pin in isolation; and,

FIG. 2 shows the overall context of the invention with the inventive fixture pin holding and locating a part for a machining operation.

### DETAILED DESCRIPTION OF THE DRAWINGS

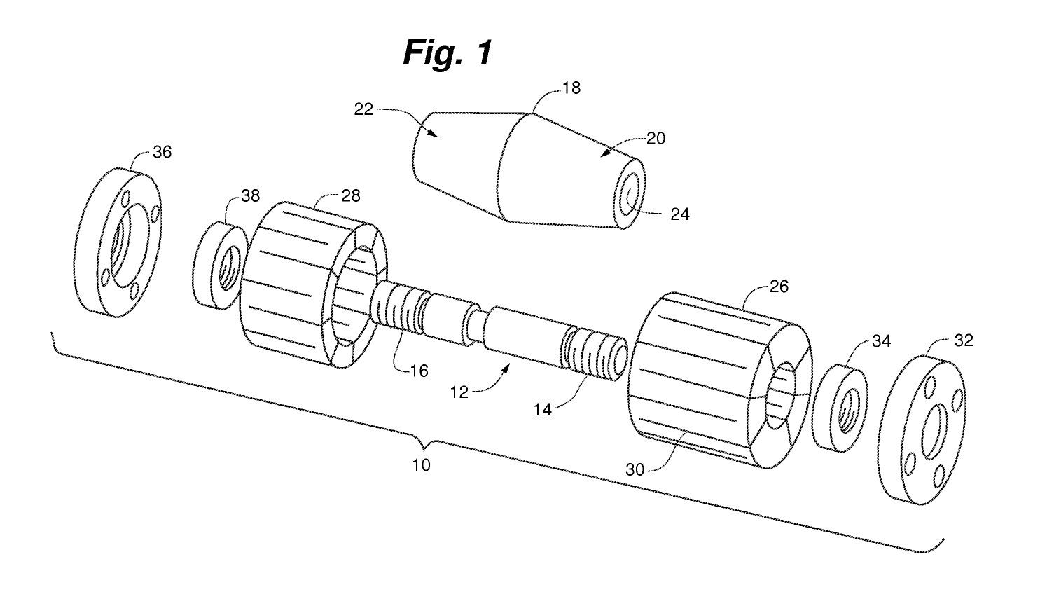

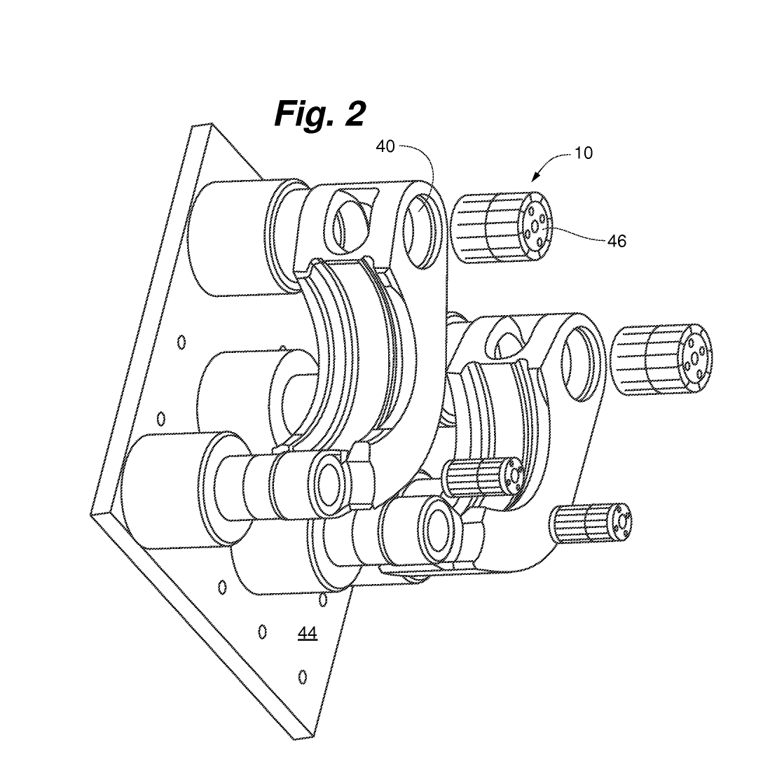

FIG. 1 shows the individual components of the fixture pin 10 assembly in an exploded view showing the relative relationship of the component parts that make up the device. The central screw spindle 12 has a left hand threaded end section 14 on one end and a right hand threaded end section 16 on the opposite end. One end or both ends of the screw spindle will have a drive fitting such as a standardized square drive or other drive fitting such as “Torx” or a screw slot. For clarity in the figure this feature is seen best as element 46 in FIG. 2.

The double taper conical body 18 has a long taper section 20 on one end and a shorter taper section 22 on the other end. To assemble the fixture pin 10 the screw spindle 12 is inserted into the bore 24 of the conical body 18 element. An optional key not shown may be inserted through a lateral hole in the conical element to pin the spindle in place. This construction may assists in unlocking the fixture pin from the work-piece on very large diameter pins. It is unnecessary on smaller diameter fixture pins.

Next the long collet collar 26 is placed on the long taper 20 and the short collar 28 is placed on the short taper 22.

In use alternating slits typified by slit 30 on each of the collars expand as the collars slide up the tapers. This expands the diameter of the fixture pin and forces it into contact with the hole in the work-piece.

The end plate 32 carries and traps a nut 34 on the “long end” while a complementary end plate 36 and nut 38 form the “short end”. When the nuts engage the threaded sections 16 and 14 respectively, rotation of the spindle screw will advance both of the tapered collars 26 and collet collar 28 along the length of the tapers to expand the diameter of the device evenly and uniformly and in synchrony to lock onto the component part to be machined.

FIG. 2 shows the overall context of the invention with one of the inventive fixture pin 10 seen over a hole 40 in the work-piece 42. The work-piece may be a large steel forging weighing 1,000 lbs. or so and the forging is positioned for a boring or milling operation by fixation on a plate 44. In use the plate 44 is mounted to the carriage of the boring machine (not seen for clarity). The exemplary fixture pin 10 will be inserted into the companion hole 40 created in a pervious operation. Once mated, the exemplary pin 10 will travel with the work-piece 40 to locate the work-piece for other machine operations.

What is claimed is:

1. A fixture pin comprising:
a central screw spindle having a first left threaded end section and a second right threaded end section;
a double tapered body having a longitudinal bore adapted to slide over said central screw spindle;
first end plate;
a first nut;
a second end plate;
a second nut;
a first collet collar;
a second collet collar;
said collet collars located on said double tapered body;
said screw spindle located within said double tapped body engaging both of said first nut and said second nut;
whereby rotation of said spindle advances said collars along said tapers.
